(19) United States
(12) Patent Application Publication
(10) Pub. No.: US 2004/0257960 A1
(43) Pub. Date: Dec. 23, 2004

(54) Optical pick-up apparatus

(76) Inventor: Noriaki Fujii, Higashihiroshima-shi (JP)

Correspondence Address: MORRISON & FOERSTER LLP, 755 PAGE MILL RD, PALO ALTO, CA, 94304-1018, US

(21) Appl. No.: 10/769,567

(22) Filed: Jan. 30, 2004

(30) Foreign Application Priority Data
Nov. 28, 2003 (JP) 2003-399764
Jan. 31, 2003 (JP) 2003-024188

(51) Int. Cl. G11B 7/00

(52) U.S. Cl. 369/112.05; 369/44.12

(57) ABSTRACT

An optical pick-up apparatus-includes a light source, an inclined multi-division phase shift diffraction grating, an objective lens that collects light emitted from the light source onto an optical recording medium, a light diverging element that-diverges reflection light reflected on the optical recording medium, and a light receiving element that receives diverged reflection light. The diffraction grating is formed on a light-transmitting rectangular substrate, and is manufactured by being cut out in such a manner that a virtual line as a symmetric axial line that forms the diffraction grating line-symmetrically, becomes parallel to at least one side of the substrate. This makes it possible to adjust the assembling position by placing the visually observable one side of the substrate, used as a guiding index, to become perpendicular to the radius direction of the optical recording medium. Hence, the assembling position adjustment of the diffraction grating can be extremely easy.

### CROSS-REFERENCE TO RELATED APPLICATIONS

This Nonprovisional application claims priority under 35 U.S.C. §119(a) on Patent Application No. 2003-399764 filed in Japan on Jan. 16, 2003, the entire contents of which are hereby incorporated by reference.

### BACKGROUND OF THE INVENTION

1. Field of the Invention

The present invention relates to an optical pick-up apparatus that records information in an optical recording medium and/or reproduces information from an optical recording medium by means of light.

2. Description of the Related Art

Optical discs, such as compact discs (abbreviated to CDs), digital versatile discs (abbreviated to DVDs), and mini discs (abbreviated to MDs), have been used as optical recording media in various fields including audio videos, computers, etc. To meet the need for a larger storage capacity, namely a quantity of information to be recorded in an optical recording medium as descried above, track pitches, which are intervals between adjacent tracks formed in the optical recording medium, are being made narrower while the inner radius near the center of the optical recording medium is being used as an information recording region.

An information recording/reproducing apparatus using such an optical recording medium records or reproduces information by focusing a light spot on the information recording surface of the optical recording medium, and allowing the light spot to follow the tracks formed in the optical recording medium. The control by which the light spot is allowed to follow the tracks is referred to as the tracking control, and the tracking control is performed by detecting light reflected on the optical recording medium with a light receiving element, and feeding back a detection signal from the light receiving element to an actuator that drives an objective lens serving as light collecting means for collecting light onto the optical recording medium. A signal used for the feedback control in driving the actuator is referred to as a tracking error signal (abbreviated to TES), and one of known methods of generating a signal to be used as a TES is the differential push-pull (abbreviated to DPP) method (see, for example, Japanese Examined Patent Publication JP-B2 4-34212).

According to the tracking error detection method by the DPP method, a diffraction grating diffracts light emitted from the light source to three beams: zero (0)—order diffracted light, plus (+) first-order diffracted light, and minus (−) first-order diffracted light. These three beam spots are irradiated onto the tracks in the optical recording medium in such a manner that their intervals become an odd multiple of one-half the track pitch, and a differential of the push-pull signals of the respective beams through the track diffraction reflection on the optical recording medium is found. According to the DPP method, because an offset in the TES can be reduced as the offsets generated in the respective push-pull signals when the objective lens is shifted in a radius direction of the optical recording medium are cancelled out with each other, it is possible to achieve a stable tracking servo.

The DPP method disclosed in JP-B2 4-34212, however, has a problem as follows. That is, because of the need for the positioning such that the beam spot intervals between the zero-order diffracted light and ±first-order diffracted light irradiated onto the optical recording medium become exactly one-half the track pitch in the radius direction of the optical recording medium, the diffraction grating has to be rotationally adjusted precisely with respect to the tracks in the optical recording medium. Also, a limitation is imposed in terms of construction that the movement trace of the objective lens has to be always on the radius of the optical recording medium. Further, for an optical recording medium having different specifications, such as the track pitch, the relation that the beam spot intervals become one-half the track pitch cannot be satisfied, and a desired TES can no longer be obtained. Hence, shared use by plural types of recording media having different specifications is not feasible.

As one of the related arts addressing such a problem, there has been proposed a tracking error detection method, in which the dependency of the beam spot positioning of the zero-order diffracted light and the ±first-order diffracted light on the track intervals is so small that offsets are rarely generated (see, for example, Japanese Unexamined Patent Publication JP-A 9-81942).

FIG. 8 is a plan view schematically showing the configuration of a phase shift diffraction grating 1 used in an optical pick-up apparatus according to a related art. The phase shift diffraction grating 1 used in the optical pick-up apparatus according to the related art is divided into two regions 3a and 3b aligned in a radius (X) direction of the optical recording medium by a parting line 2, which is parallel to a tangential direction of the tracks in the optical recording medium (hereinafter, referred to as a track (Y) direction), and is configured in such a manner that the cyclic structure of the region 3b has a phase difference of 180 degrees with respect to the cyclic structure of the region 3a.

When light 4 emitted from the light source strikes the phase shift diffraction grating 1 configured as described above, a phase difference of 180 degrees is generated in the ±first-order diffracted light having been diffracted by the phase shift diffraction grating 1. Let the beam of the zero-order diffracted light be a main beam, and the beams of the ±first-order diffracted light be sub beams, then a push-pull signal of the main beam to which no phase difference is added and push-pull signals of the sub beams to which the phase difference of 180 degrees as described above is added are signals whose phases are shifted by 180 degrees with each other. Hence, it is possible to detect a DPP signal without the need for the positioning such that the sub beams are shifted by one-half the track pitch with respect to the main beam.

This allows the optical pick-up apparatus provided with the phase shift diffraction grating 1 to perform recording/reproduction operations for plural types of optical recording media having different track pitches with the use of a single optical pick-up.

The technique disclosed in JP-A 9-81942 can reduce the dependency of the beam spot positioning of the main beam and the sub beams on the track intervals; however, there is a problem that the phase shift diffraction grating 1 has to be adjusted finely so that the two sub beams are positioned on the same track. Hence, the technique disclosed in JP-A 9-81942 is insufficient to simplify the position adjustment of the diffraction grating.

As another related art to achieve simplified position adjustment of the diffraction grating, there has been proposed the use of a phase shift diffraction grating in which the cyclic structure of troughs and crests of the grating are partially inverted as a diffraction grating that generates three beams: the zero-order diffracted light serving as the main beam and the ±first-order diffracted light serving as the sub beams (see, for example, Japanese Unexamined Patent Publication JP-A 2001-250250).

FIG. 9 is a plan view schematically showing the configuration of a phase shift diffraction grating 5 used in an optical pick-up apparatus according to another related art. The phase shift diffraction grating 5 is configured in such a manner that in an X-Y plane having the track (Y) direction and the radius (X) direction of the optical recording medium as the axes, for example, a first quadrant 6 alone has a phase difference of 180 degrees in the cyclic structure in comparison with the other quadrants.

For the sub beams, serving as the ±first-order diffracted light generated as incident light 7 from the light source is diffracted by the phase shift diffraction grating 5, a phase difference of 180 degrees is added to the portion corresponding to the first quadrant 6 alone. The push-pull signals using the sub beams, which are generated by the phase shift diffraction grating 5 and to which a phase difference is added to the first quadrant 6 alone, have nearly zero amplitude, which is smaller than the amplitude of the push-pull signal of the main beam to which no phase difference is added. In this manner, because the push-pull signals are not detected regardless of the positions of the sub beams with respect to the tracks, it is possible to obtain substantially the same signal whether the sub beams and the main beam are positioned on the same track or on the different tracks. Hence, neither the intervals between the main beam and the sub beams nor the positioning of the sub beams has to be concerned, and the rotational position adjustment of the phase shift diffraction grating 5 can be thus simplified.

The technique disclosed in JP-A 2001-250250, however, has a problem as follows. That is, depending on the relative positional relation among the light source, the diffraction grating, and the objective lens serving as the light collecting means, the track modulation components of the push-pull signals of the sub beams may not be cancelled out as are designed. This is attributed to a shift from a design value of a utilization ratio of a region to which no phase difference is added and a region to which a phase difference is added in an effective light beam passing through the diffraction grating. Such a shift is resulted from precision of the assembling position adjustment of the apparatus or from the shifting of the objective lens in the radius direction of the optical recording medium during operation.

As a related art to broaden the tolerance of precision of the assembling position adjustment of the apparatus in solving such a problem, there has been proposed a diffraction grating referred to as an inclined multi-division phase shift diffraction grating 8 as shown in FIGS. 10A and 10B (see Document: Tetsuo Ueyama, Keiji Sakai, Yukio Kurata, “HOLOGRAM LASER UNIT FOR DVD II (REPRODUCTION TYPE), Corrected papers of 2002 Annual Meeting of JSPE Kansai Division, The Japan Society for Precision Engineering, Aug. 1, 2002, pp. 77-78). Also, FIG. 11 is a perspective view schematically showing the configuration of a conventional optical pick-up apparatus 9 provided with the inclined multi-division phase shift diffraction grating 8 shown in FIGS. 10A and 10B.

The inclined multi-division phase shift diffraction grating 8 is formed line-symmetrically with respect to a virtual line 11 perpendicular to the radius (X) direction of an optical recording medium 10 being inserted, and is divided into a plurality of diffraction regions 12 formed to have an inclination angle θ with respect to the virtual line 11 while the grating cycles of one diffraction region 12a and the other adjacent diffraction region 12b have a phase difference of 180 degrees with each other.

FIG. 10B is an enlarged view showing a region A enclosed by a closed curve shown in FIG. 10A, and as shown in FIG. 10B, each diffraction region 12 forms a diffraction grating as a solid portion 13 of FIG. 10B and a blank portion 14 of FIG. 10B are repeated in the track (Y) direction. The adjacent diffraction regions 12a and 12b are formed to be shifted by one-half the alignment pitch, which gives rise to a phase difference of 180 degrees as described above.

A signal detecting operation by the conventional optical pick-up apparatus 9 will now be described with reference to FIG. 11. Light 16 emitted from a light source 15 is diffracted to a main beam 17, which is the zero-order diffracted light, and two beams, that is, first and second sub beams 18 and 19, which are the ±first-order diffracted light, by the inclined multi-division phase shift diffraction grating 8. Light thus diffracted is made into almost parallel light by a collimator lens 20, and is then collected and irradiated onto the optical recording medium 10 by an objective lens 21. Light reflected on the optical recording medium 10 passes through the objective lens 21 and the collimator lens 20 again, is then diverged by a hologram 22 to enter a light receiving element 23, and the reception thereof is detected by the light receiving element 23.

The light receiving element 23 is configured to receive diverged light of the main beam 17 and the first and second sub beams 18 and 19 with the use of two regions of the hologram 22 divided by a parting line parallel to the track (Y) direction of the optical recording medium 10, and thereby obtains a push-pull signal from a difference signal of each beam.

FIGS. 12A through 12C are views showing an example in a case where the sub beam is received by the light receiving element 23, and FIG. 13 is an enlarged view of FIG. 12C. FIGS. 12B and 12C represent, for example, beam spots when the first sub beam 18 is being received by the light receiving element 23. Within the spot of the first sub beam 18 are formed superimposed portions 25 and 26 of spots 18a and 18b of light diffracted by the concavity and convexity formed by a land portion 10a and a groove portion 10b that together define the tracks in the optical recording medium 10.

In the sub beams, a region to which a phase difference is added and a region to which no phase difference is added are formed by the inclined multi-division phase shift diffraction grating 8. Also, because a phase difference is conferred through diffraction by the land portion 10a and the groove portion 10b in the optical recording medium 10, dark portions 27 to which the phase difference has been added and bright portions 28 to which no phase difference has been added are formed as being inverted with each other in the superimposed portion 25 and the superimposed portion 26 of light.

FIG. 14 is a view showing push-pull signals by the main beam 17 and the first and second sub beams 18 and 19. FIG. 14 shows a push-pull signal (MPP) of the main beam 17 and push-pull signals (SPP1 and SPP2) of the first and second sub beams 18 and 19, all obtained by the inclined multi-division phase shift diffraction grating 8. As has been described, because the dark portions 27 and the bright portions 28 formed in the superimposed portions 25 and 26 of light in the sub beam are inverted, while the areas of the superimposed portion 25 and the superimposed portion 26 become almost equal, the modulation components of the tacks are cancelled out. Hence, as shown in FIG. 14, the track modulation components of SPP1 and SPP2 of the first and second sub beams 18 and 19 become extremely small in comparison with the track modulation components of MPP of the main beam 17.

In this manner, it is possible to obtain SPP1 and SPP2 in which the track modulation components are suppressed in substantially the same manner whether the first and second sub beams 18 and 19 and the main beam 17 are positioned on different tracks or on the same track. In other words, because push-pull signals with reduced track modulation components can be obtained regardless of the positions of the sub beams on the track, it is possible to simplify the rotational position adjustment of the inclined multi-division phase shift diffraction grating 8. Further, because the bright portions 28 and the dark portions 27 formed in the superimposed portions 25 and 26 of light are segmented into small regions by the inclined multi-division phase shift diffraction grating 8, the canceling of the track modulation components gives an extremely small influence to the rotational position of the diffraction grating, which broadens the tolerance of precision of the assembling position adjustment of the apparatus.

However, the technique disclosed in the above-mentioned Document has a problem as follows. That is, the inclined multi-division phase shift diffraction grating 8 can simplify the assembling position adjustment of the apparatus; however, the multi-divided diffraction regions 12 have orientations, because they are formed to have the aforementioned inclination angle θ determined in advance with respect to the virtual line 11. Hence, there is still a need for fine adjustment such that matches the direction of the virtual line 11 on the inclined multi-division phase shift diffraction grating 8 with the track (Y) direction perpendicular to the radius (X) direction of the optical recording medium 10 being inserted during the assembling position adjustment of the apparatus. It should be noted that because the virtual line 11 of the inclined multi-division phase shift diffraction grating 8 is an imaginary line and cannot be observed visually, it cannot be used as a guiding index during the assembling position adjustment of the inclined multi-division phase shift diffraction grating 8. The above-mentioned document fails to disclose a technique of adjusting the inclined multi-division phase shift diffraction grating 8 having the orientation finely in a particular direction with respect to the track (Y) direction of the optical recording medium 10.

### SUMMARY OF THE INVENTION

An feature of the invention is to provide an optical pick-up apparatus in which the assembling position adjustment of a phase shift diffraction grating having an orientation is extremely easy.

The invention provides an optical pick-up apparatus that records information in an optical recording medium and/or reproduces information from the optical recording medium by means of light, comprising:

a light source for emitting light;

a diffraction grating for diffracting light emitted from the light source, the diffraction grating being formed line-symmetrically with respect to a virtual line perpendicular to a radius direction of the optical recording medium in an attached state, and divided into a plurality of diffraction regions formed in such a manner that each has an inclination angle with respect to the virtual line and grating cycles of adjacent diffraction regions have a phase difference of 180 degrees with each other;

light collecting means for collecting light emitted from the light source onto the optical recording medium;

a light diverging element for diverging reflection light reflected on the optical recording medium; and

a light receiving element for receiving the reflection light diverged by the light diverging element,

wherein the diffraction grating is formed on a rectangular substrate made of a light-transmitting material.

In the invention, the diffraction grating is disposed between the light source and the light diverging element.

In the invention, the diffraction grating is formed on the substrate on a surface facing the light source, and the light diverging element is formed on the substrate on a surface facing the light collecting means.

In the invention, the light source is formed integrally with the substrate on which the diffraction grating and the light diverging element are formed.

In the invention, the light source is formed in such a manner that an outer shape thereof is shaped like a rectangular parallelepiped, and that a width w, which is a dimension in a direction parallel to a surface of the optical recording medium, is larger than a thickness t, which is a dimension in a direction perpendicular to the surface of the optical recording medium (w>t).

The invention also provides an optical pick-up apparatus that records information in an optical recording medium and/or reproduces information from the optical recording medium by means of light, comprising:

a light source for emitting light;

a diffraction grating for diffracting light emitted from the light source, the diffraction grating being formed line-symmetrically with respect to a virtual line perpendicular to a radius direction of the optical recording medium in an attached state, and divided into a plurality of diffraction regions formed in such a manner that each has an inclination angle with respect to the virtual line and grating cycles of adjacent diffraction regions have a phase difference of 180 degrees with each other;

light collecting means for collecting light emitted from the light source onto the optical recording medium;

a light diverging element for diverging reflection light reflected on the optical recording medium; and

a light receiving element for receiving the reflection light diverged by the light diverging element,

wherein the diffraction grating is formed integrally with the light collecting means.

According to the invention, the optical pick-up apparatus includes a diffraction grating diffracting light emitted from the light source, which is referred to as an inclined multi-division phase shift diffraction grating formed line-symmetrically with respect to a virtual line perpendicular to a radius direction of the optical recording medium in an attached state and divided into a plurality of diffraction regions formed in such a manner that each has an inclination angle with respect to the virtual line and grating cycles of adjacent diffraction regions have a phase difference of 180 degrees with each other, and this diffraction grating is formed on a rectangular substrate made of a light-transmitting material.

For the inclined multi-division phase shift diffraction grating having an orientation, a desirable state for operations of the optical pick-up apparatus is that the position adjustment is performed in such a manner that the aforementioned virtual line of the diffraction grating becomes perpendicular to the radius direction of the optical recording medium in the attached state. The diffraction grating can be assembled and adjusted at a desired position with respect to the radius direction of the optical recording medium through an extremely easy technique that the diffraction grating is manufactured in advance in such a manner that the virtual line thereof is aligned with at least one side of the rectangular substrate when it is formed on the rectangular substrate made of the light-transmitting material, and then the assembling position adjustment is performed in such a manner that the aforementioned one side of the substrate becomes perpendicular to the radius direction of the optical recording medium.

Also, according to the invention, the diffraction grating is disposed between the light source and the light diverging element. By placing the diffraction grating in this manner, no reflection light from the optical recording medium passes through the diffraction grating, and it is thus possible to prevent the occurrence of an unwanted signal caused by stray light due to diffraction of the reflection light. In a case where a plurality of light sources having different wavelengths are mounted, a diffraction grating suitable for the respective light sources can be provided by positioning the diffraction grating closer to the light sources.

Also, according to the invention, the diffraction grating is formed on the substrate on a surface facing the light source, and the light diverging element is formed on the substrate on a surface facing the light collecting means. In this manner, by forming the inclined multi-division phase shift diffraction grating and the light diverging element integrally with the substrate, not only can the number of members be reduced, but also an installation space that is otherwise needed for an omitted member can be saved. Hence, a contribution to a reduction of the apparatus in size can be made.

Also, according to the invention, the light source is formed in such a manner that an outer shape thereof is shaped like a rectangular parallelepiped, and that a width w, which is a dimension in a direction parallel to a surface of the recording medium, is larger than a thickness t, which is a dimension in a direction perpendicular to the surface of the recording medium (w>t). More preferably, the light source is formed integrally with the substrate on which the diffraction grating and the light diverging element are formed.

An apparatus that uses a semiconductor laser as the light source and a hologram as the light diverging element, while the light source, the diffraction grating, and the light diverging element are formed integrally with the substrate, is referred to as a hologram laser. By using the inclined multi-division phase shift diffraction grating as the diffraction grating in this hologram laser, the need for the rotational adjustment of the hologram laser is eliminated, and a rotational adjustment mechanism can be omitted. Hence, not only can the rotational adjustment process of the hologram laser during the assembling adjustment of the apparatus be omitted, but also deterioration of the reliability caused by the rotational shift of the hologram laser can be prevented. Also, because no rotation adjustment of the hologram laser is necessary, a space needed for the rotational adjustment of the hologram laser, that is, a so-called adjustment allowance, is no longer needed. Hence, the optical pick-up apparatus can be reduced in thickness by eliminating the adjustment allowance.

Also, according to the invention, the optical pick-up apparatus includes an inclined multi-division phase shift diffraction grating, and the inclined multi-division phase shift diffraction grating is formed integrally, for example, with an objective lens serving as the light collecting means. The diffraction grating is provided on the objective lens in such a manner that the virtual line of the inclined multi-division phase shift diffraction grating matches with a direction perpendicular to the tracking direction of the objective lens. By inserting the objective lens provided with the diffraction grating in such a manner that the tracking in the radius direction of the optical recording medium is allowed, the virtual line of the diffraction grating can be aligned to be perpendicular to the radius direction of the optical recording medium. This makes the assembling position adjustment of the diffraction grating extremely easy, and the assembling position adjustment process of the diffraction grating can be omitted. Also, because any other additional member is not necessary to provide the diffraction grating, a space can be saved due to omission of any other additional member. Hence, a contribution to a reduction of the apparatus in size can be made.

### BRIEF DESCRIPTION OF THE DRAWINGS

Other and further objects, features, and advantages of the invention will be more explicit from the following detailed description taken with reference to the drawings wherein:

FIG. 1 is a view schematically showing the configuration of an optical pick-up apparatus according to a first embodiment of the invention;

FIG. 2 is a perspective view schematically showing the configuration of a diffraction element provided to the optical pick-up apparatus shown in FIG. 1;

FIG. 3 is a view schematically showing the configuration of an optical pick-up apparatus according to a second embodiment of the invention;

FIG. 4 is a view schematically showing the configuration of an optical pick-up apparatus according to a third embodiment of the invention;

FIG. 5 is a view schematically showing the configuration of an optical pick-up apparatus according to a fourth embodiment of the invention;

FIG. 6 is a perspective view schematically showing the configuration of an optical pick-up apparatus according to a fifth embodiment of the invention;

FIG. 7 is a view schematically showing the configuration of an optical pick-up apparatus according to a sixth embodiment of the invention;

FIG. 8 is a plan view schematically showing the configuration of a phase shift diffraction grating used in an optical pick-up apparatus according to a related art;

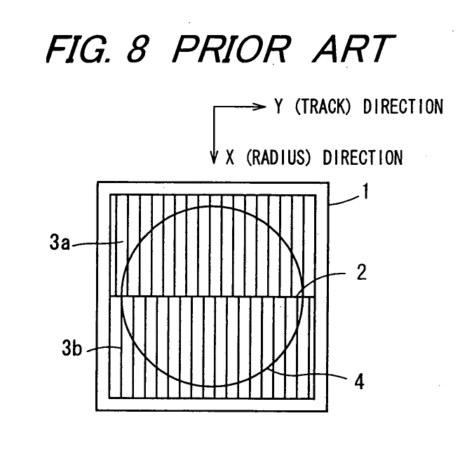

FIG. 9 is a plan view schematically showing the configuration of a phase shift diffraction grating used in an optical pick-up apparatus according to another related art;

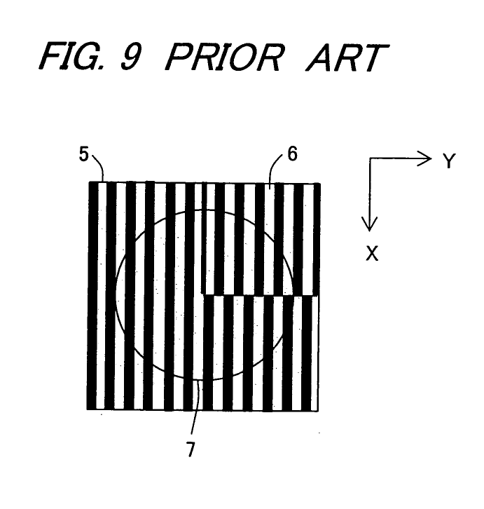

FIGS. 10A and 10B are plan views schematically showing the configuration of an inclined multi-division phase shift diffraction grating;

FIG. 11 is a perspective view schematically showing the configuration of a conventional optical pick-up apparatus provided with the inclined multi-division phase shift diffraction grating shown in FIGS. 10A and 10B;

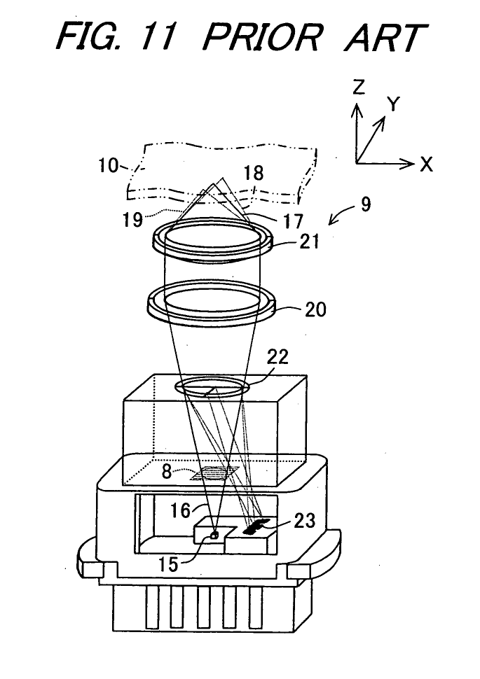

FIGS. 12A through 12C are views showing an example in a case where a sub beam is received by a light receiving element;

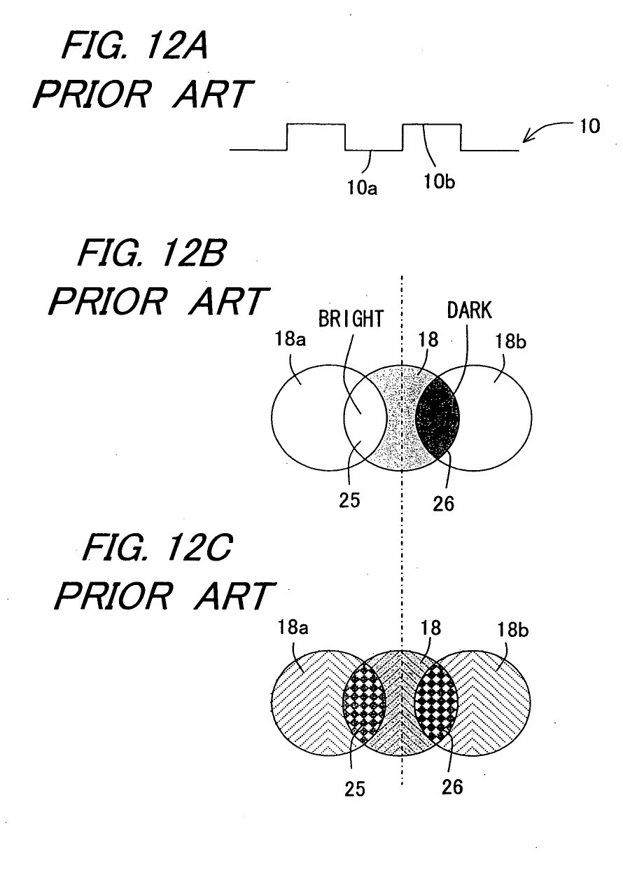

FIG. 13 is an enlarged view of FIG. 12C; and

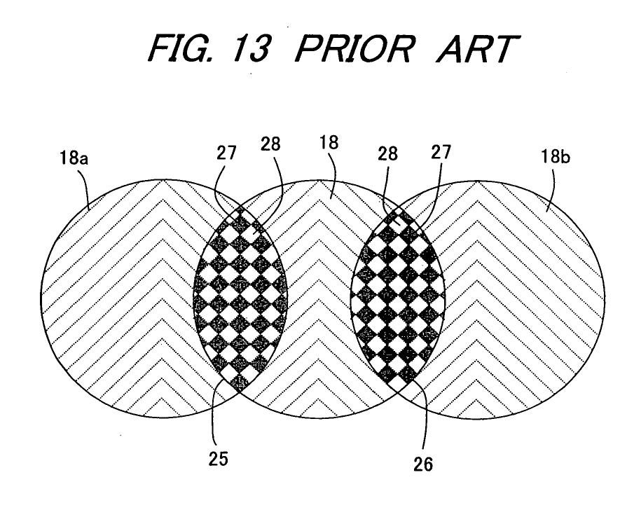

FIG. 14 is a view showing push-pull signals of a main beam 17 and first and second sub beams.

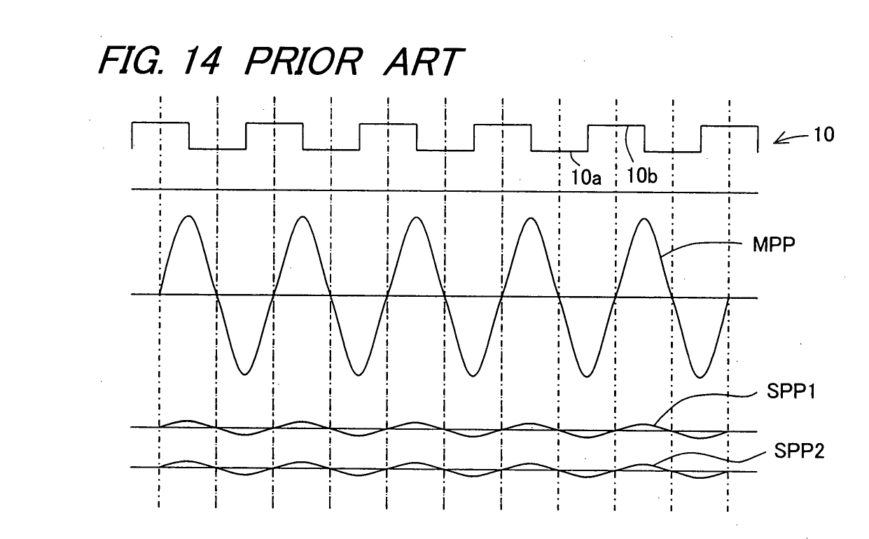

### DETAILED DESCRIPTION

Now referring to the drawings, preferred embodiments of the invention are described below.

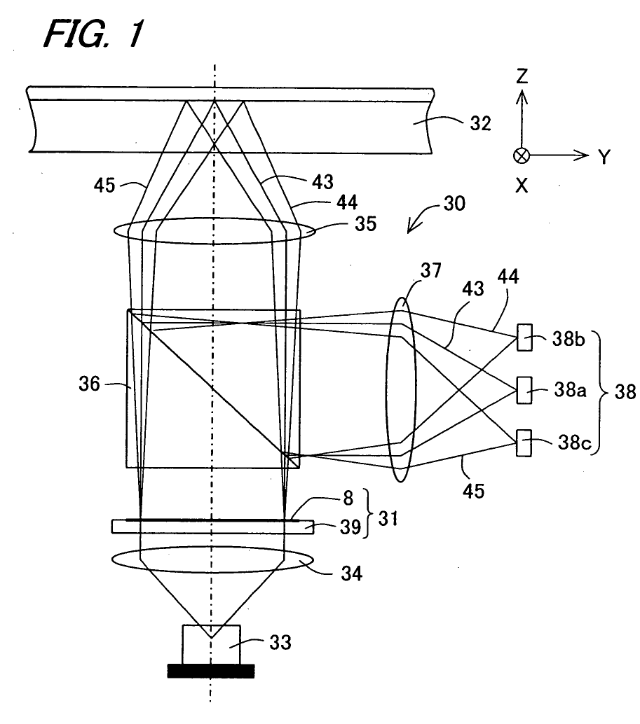

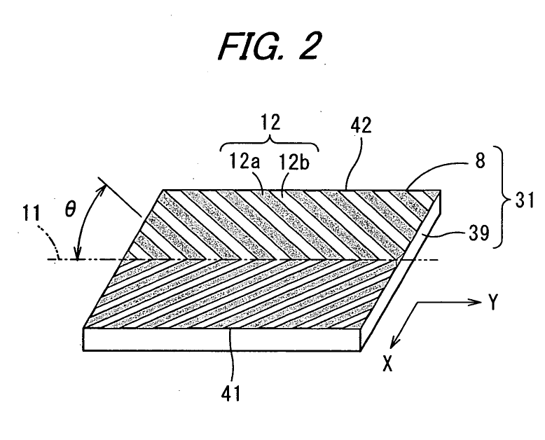

FIG. 1 is a view schematically showing the configuration of an optical pick-up apparatus 30 according to a first embodiment of the invention. FIG. 2 is a perspective view schematically showing the configuration of a diffraction element 31 provided to the optical pick-up apparatus 30 shown in FIG. 1. The optical pick-up apparatus 30 is used to record information in an optical recording medium 32 and/or reproduce information from the optical recording medium 32 by means of light.

The optical pick-up apparatus 30 includes a light source 33 for emitting light, a collimator lens 34 for making light emitted from the light source 33 into almost parallel light, a diffraction grating 8 for diffracting light emitted from the light source 33, an objective lens 35 serving as light collecting means for collecting light emitted from the light source 33 onto the optical recording medium 32, a light diverging element 36 for diverging reflection light reflected on the optical recording medium 32, a light collecting lens 37 for collecting light diverged by the light diverging element 36 to a light receiving element 38 described below, and the light receiving element 38 for receiving reflection light diverged by the light diverging element 36 and collected by the light collecting lens 37. A semiconductor laser may suitably be used as the light source 33.

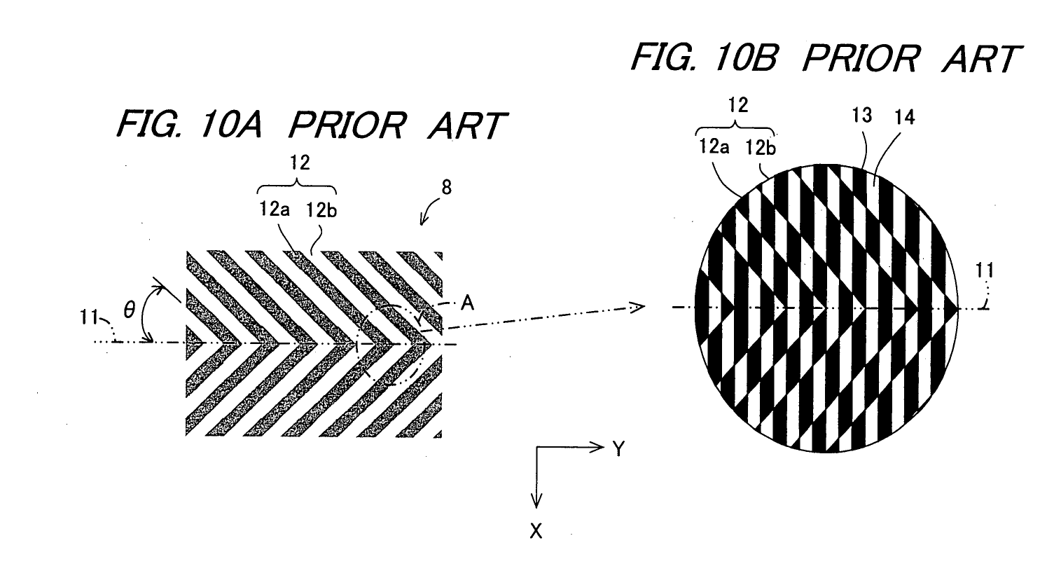

The diffraction grating 8 is formed on a rectangular substrate 39 made of a light-transmitting material. The diffraction grating 8 is the inclined multi-division phase shift diffraction grating 8 described above shown in FIGS. 10A and 10B, and because the structure and functions thereof are the same as those described above, a description thereof is omitted. The substrate 39 is made of a light-transmitting material, for example, silica glass, acrylic based resin, etc., and to be more exact, it has a shape of a thin-plate rectangular parallelepiped, and when viewed in a plane, a surface thereof, on which the inclined multi-division phase shift diffraction grating 8 is formed, is of a rectangular shape (oblong in this embodiment). The substrate 39 and the inclined multi-division phase shift diffraction grating 8 formed integrally with the substrate 39 are together referred to as the diffraction element 31 for ease of explanation. The diffraction element 31 is manufactured by being cut out in such a manner that two long sides 41 and 42 of the oblong (rectangle) forming the surface, on which the inclined multi-division phase shift diffraction grating 8 is formed, become parallel to a virtual line 11. The diffraction element 31, in which the inclined multi-division phase shift diffraction grating 8 is formed, is disposed between the light source 33 and the light diverging element 36.

The light diverging element 36 is a polarizing beam splitter in this embodiment, and reflects and guides each of a main beam 43 and first and second sub beams 44 and 45 reflected on the optical recording medium 32 to the light collecting lens 37. The light receiving element 38 is a photoelectric converting element comprising, for example, a photodiode. The light receiving element 38 is configured to include a light receiving portion 38a for receiving the main beam 43, a light receiving portion 38b for receiving the first sub beam 44, and a light receiving portion 38c for receiving the second sub beam 45. Each of the light receiving portions 38a, 38b, and 38c is a 2-division photo-detector that is divided by a parting line parallel to the track (Y) direction of the optical recording medium 32, and is able to find a differential of a push-pull signal of each beam.

Because the optical pick-up apparatus 30 includes the inclined multi-division phase shift diffraction grating 8 as the diffraction grating, as is with the description above, the track modulation components of the push-pull signals of the first and second sub beams 44 and 45 are extremely small in comparison with the track modulation components of the push-pull signal of the main beam 43, and a push-pull signal with reduced track modulation components can be therefore obtained regardless of the positions of the sub beams on the track. It is thus possible to simplify the rotational position adjustment of the inclined multi-division phase shift diffraction grating 8.

Also, the inclined multi-division phase shift diffraction grating 8 is formed on the substrate 39 and is manufactured by being cut out in such a manner that the virtual line 11 becomes parallel to the two long sides 41 and 42 of the substrate 39 when the diffraction element 31 is manufactured. The inclined multi-slicing phase shift diffraction grating 8 has the orientation, and it is therefore necessary to adjust the position so that the virtual line 11 falls within ±3 degrees with respect to the track (Y) direction perpendicular to the radius (X) direction of the optical recording medium 32. Because the diffraction element 31 has been formed in such a manner that the virtual line 11 and the two long sides 41 and 42 of the substrate 39 are parallel to each other, the inclined multi-division phase shift diffraction grating 8 can be readily attached in such a manner that the two long sides 41 and 42 of the substrate 39 become parallel to the track (Y) direction of the optical recording medium 32, by using the visually observable long sides 41 and 42 of the substrate 39 as the guiding index for the assembling position adjustment. In this manner, the assembly adjustment can be performed quite easily in such a manner that the virtual line 11 of the inclined multi-division phase shift diffraction grating 8 is placed to a desired position, that is, within ±3 degrees with respect to the track (Y) direction of the optical recording medium 32.

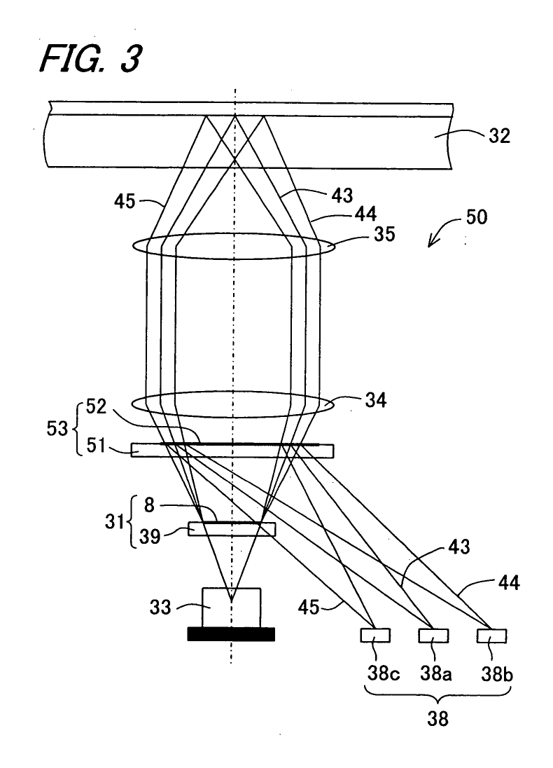

FIG. 3 is a view schematically showing the configuration of an optical pick-up apparatus 50 according to a second embodiment of the invention. For the optical pick-up apparatus 50 according to this embodiment, like components with respect to the optical pick-up apparatus 30 according to the first embodiment of the invention are denoted by the same reference numerals, and a description of these components is omitted.

It should be noted for the optical pick-up apparatus 50 that a light diverging element 53 is comprised by means of a hologram 52, which constitutes a light diverging pattern, on a substrate 51 made of a light-transmitting material. Herein, elements having a light diverging function are collectively referred to as the light diverging elements, and a component like the hologram 52 that effects the light diverging function by means of a pattern provided on the light-transmitting substrate 51 is referred to as a light diverging pattern.

The light diverging element 53 that diverges reflection light by means of the hologram 52 is smaller in dimension than the polarizing beam splitter serving as the light diverging element 36 in the optical pick-up apparatus 30 according to the first embodiment of the invention, and therefore occupies a smaller installation space. Hence, a contribution to a reduction of the apparatus in size can be made.

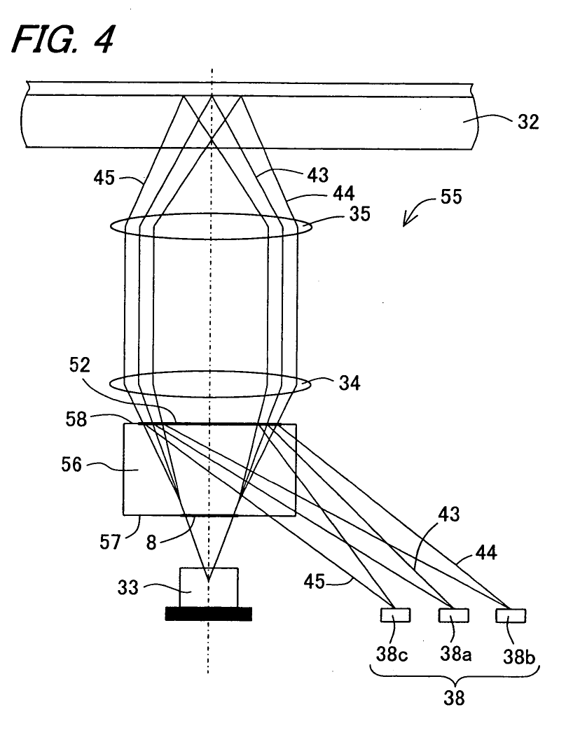

FIG. 4 is a view schematically showing the. configuration of an optical pick-up apparatus 55 according to a third embodiment of the invention. For the optical pick-up apparatus 55 according to this embodiment, like components with respect to the optical pick-up apparatus 50 according to the second embodiment of the invention will be denoted by the same reference numerals, and a description of these components is omitted. It should be noted for the optical pick-up apparatus 55 that the inclined multi-division phase shift diffraction grating 8 and the hologram 52 which constitutes a light diverging pattern share a substrate 56 made of a light-transmitting material. In other words, the inclined multi-division phase shift diffraction grating 8 is formed on the substrate 56 on a surface 57 facing the light source 33 while the hologram 52 is formed on the substrate 56 on a surface 58 facing the objective lens 35 (the nearest is the collimator lens 34).

In this manner, by integrally forming the inclined multi-division phase shift diffraction grating 8 and the hologram 52 with the substrate 56 on the opposing surfaces thereof, respectively, two members can be combined into one component. Hence, the number of the members can be reduced, and so is the apparatus in size.

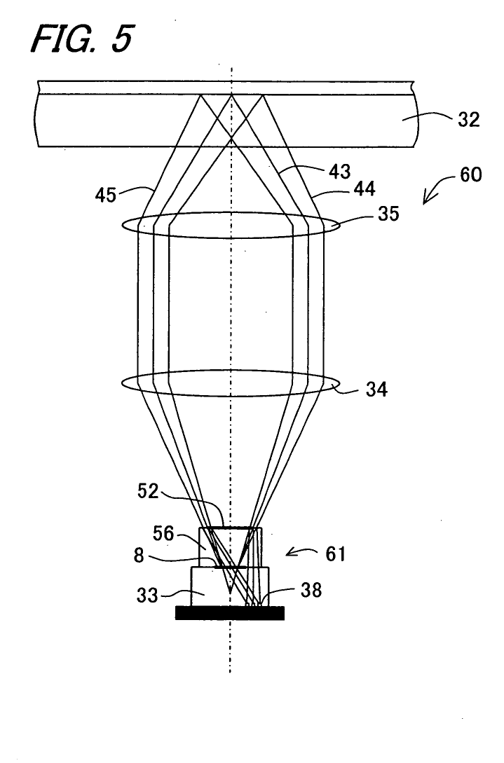

FIG. 5 is a view schematically showing the configuration of an optical pick-up apparatus 60 according to a fourth embodiment of the invention. For the optical pick-up apparatus 60 according to this embodiment, like components with respect to the optical pick-up apparatus 55 according to the third embodiment of the invention will be denoted by the same reference numerals, and a description of these components is omitted.

It should be noted for the optical pick-up apparatus 60 that the light source 33 is formed integrally with the substrate 56 on which the inclined multi-division phase shift diffraction grating 8 and the hologram 52 are formed; moreover, the light receiving element 38 is enclosed. In this manner, by forming a so-called hologram laser 61, in which the light source 33, the inclined multi-division phase shift diffraction grating 8, the hologram 52, and the light receiving element 38 are formed integrally, the number of members can be reduced further, which enables a further reduction of the apparatus in size.

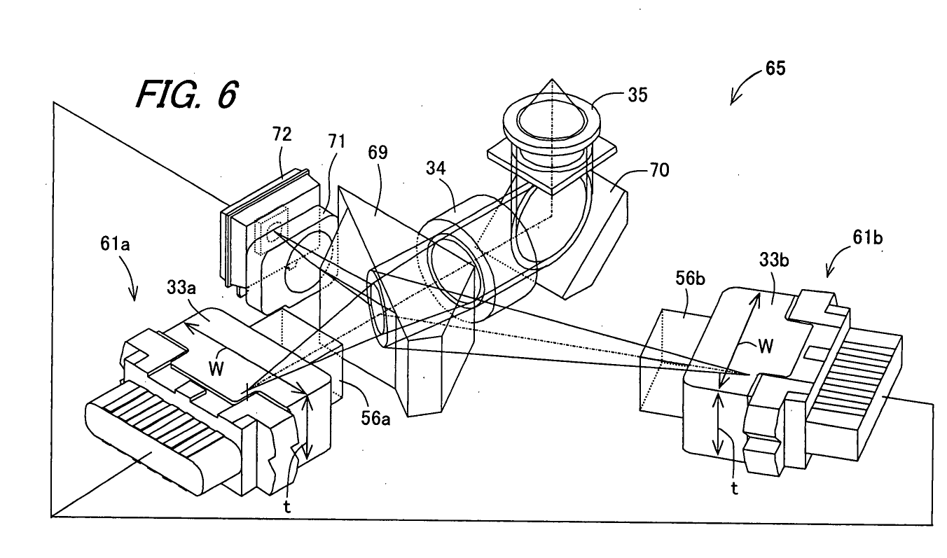

FIG. 6 is a perspective view schematically showing the configuration of an optical pick-up apparatus 65 according to a fifth embodiment of the invention. For the optical pick-up apparatus 65 according to this embodiment, like components with respect to the optical pick-up apparatus 60 according to the fourth embodiment of the invention will be denoted by the same reference numerals, and a description of these components is omitted.

The optical pick-up apparatus 65 is configured to include two hologram lasers 61a and 61b, so that it is able to record/reproduce information in/from optical recording media of two types having different specifications by means of light of two kinds having different wavelengths. In the optical pick-up apparatus 65, light sources 33a and 33b included respectively in the hologram lasers 61a and 61b are semiconductor lasers, and the outer shape of each is shaped like a rectangular parallelepiped. In the light sources 33a and 33b, a width w, which is a dimension in a direction parallel to the surface of an optical recording medium in an attached state (not shown), is larger than a thickness t, which is a dimension in a direction perpendicular to the surface of the optical recording medium (w>t). It should be noted that the hologram 52 and the inclined multi-division phase shift diffraction grating 8 are formed integrally with each of the substrates 56a and 56b provided respectively to the hologram lasers 61a and 61b; however, they are omitted from FIG. 6 to avoid the drawing from becoming too complicated.

Because each of the hologram lasers 61a and 61b includes the inclined multi-division phase shift diffraction grating 8, no rotational position adjustment is necessary. In addition, by manufacturing the inclined multi-division phase shift diffraction grating 8 in advance in such a manner that the virtual line 11 thereof becomes parallel to the side of the substrate 56a, 56b as described above, the alignment (position determination) during the assembling position adjustment can be readily performed. Hence, it is no longer necessary to provide the hologram lasers 61a and 61b with a rotational adjustment allowance, which is a space used for rotational adjustment about the axis of light emitted from the hologram lasers 61a and 61b. This reduces the thickness t of the hologram lasers 61a and 61b, which can directly reduce the thickness of the apparatus. It is thus possible to reduce the apparatus in thickness.

A signal detecting operation of the optical pick-up apparatus 65 will now be described with reference to FIG. 6. Light emitted from the hologram laser 61a passes through the light diverging element 69 and is made into almost parallel light by the collimator lens 34. Then, the light path thereof is bent by approximately 90 degrees by a rising mirror 70 and the light enters the object lens 35. Light collected and irradiated onto an optical recording medium (not shown) by the objective lens 35 is reflected on the optical recording medium and passes through the objective lens 35 again. Then, the optical path thereof is bent by the rising mirror 70, and the light passes through the collimator lens 34 and the light diverging element 69, after which the light enters the hologram laser 61a. Light that enters the hologram laser 61a is diverged by the hologram, and is received by the light receiving element enclosed in the light source 33a.

Light emitted from the other hologram laser 61b is reflected on the light diverging element 69 and guided to the collimator lens 34. Light that enters the collimator lens 34 is made into almost parallel light, and the optical path thereof is bent by approximately 90 degrees by the rising mirror 70, after which the light enters the objective lens 35. Light collected and irradiated onto the optical recording medium by the objective lens 35 is reflected on the optical recording medium and passes through the objective lens 35 again. Then, the optical path thereof is bent by the rising mirror 70, and the light passes through the collimator lens 34, after which the light is reflected on the light diverging element 69 and enters the hologram laser 61b. Light that enters the hologram laser 61b is diverged by the hologram, and is received by the light receiving element enclosed in the light source 33b.

In this manner, by including the light diverging element 69 that diverges light by transmitting and reflecting light depending on the wavelength thereof, the optical pick-up apparatus 65 guides light of two kinds having different wavelengths and emitted from the two hologram lasers 61a and 61b, respectively, to the optical recording medium, and thereby is able to detect reflection light from the optical recording medium.

Part of light emitted from the hologram laser 61a is reflected on the light diverging element 69, and part of light emitted from the hologram laser 61b passes through the light diverging element 69. Then, each of the reflection light and passing light enters an automatic power control unit 72 (abbreviated to APC) by means of a light collecting lens 71. The APC 72 feeds back a control signal corresponding to a quantity of reception light to each of the light sources 33a and 33b, and thereby performs control by which an output of light emitted from the light sources 33a and 33b is stabilized.

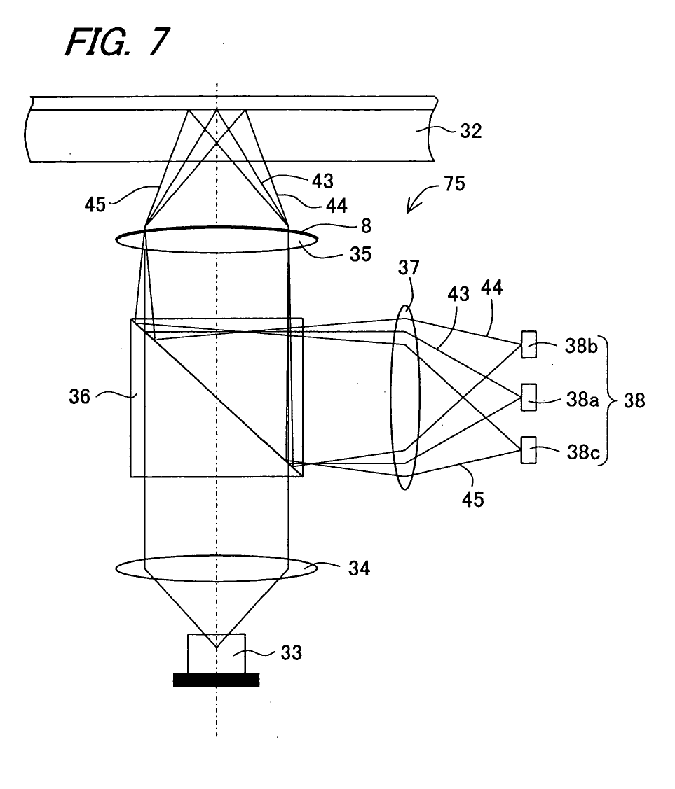

FIG. 7 is a view schematically showing the configuration of an optical pick-up apparatus 75 according to a sixth embodiment of the invention. For the optical pick-up apparatus 75 according to this embodiment, like components with respect to the optical pick-up apparatus 30 according to the first embodiment of the invention will be denoted by the same reference numerals, and a description of these components is omitted.

It should be noted for the optical pick-up apparatus 75 that the inclined multi-division phase shift diffraction grating 8 is formed integrally with the objective lens 35. The inclined multi-division phase shift diffraction grating 8 is provided on the objective lens. 35 in such a manner that the virtual line 11 of the inclined multi-division phase shift diffraction grating 8 matches with a direction perpendicular to the tracking direction of the objective lens 35, and the objective lens 35 provided with the inclined multi-division phase shift diffraction grating 8 is inserted in such a manner that the tacking in the radius direction of the optical recording medium 32 is allowed. As a consequence, the virtual line 11 of the inclined multi-division phase shift diffraction grating 8 can be aligned to be perpendicular to the radius direction of the optical recording medium 32.

This makes the assembling position adjustment of the inclined multi-division phase shift diffraction grating 8 extremely easy, and the assembling position adjustment process of the inclined multi-division phase shift diffraction grating 8 can be omitted. Also, because any other additional member is not necessary to provide the inclined multi-division phase shift diffraction grating 8, a space can be saved due to omission of any other additional member. Hence, a contribution to a reduction of the apparatus in size can be made.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical pick-up apparatus that records information in an optical recording medium and/or reproduces information from the optical recording medium by means of light, comprising:
a light source for emitting light;
a diffraction grating for diffracting light emitted from the light source, the diffraction grating being formed line-symmetrically with respect to a virtual line perpendicular to a radius direction of the optical recording medium in an attached state, and divided into a plurality of diffraction regions formed in such a manner that each has an inclination angle with respect to the virtual line and grating cycles of adjacent diffraction regions have a phase difference of 180 degrees with each other;
light collecting means for collecting light emitted from the light source onto the optical recording medium;
a light diverging element for diverging reflection light reflected on the optical recording medium; and
a light receiving element for receiving the reflection light diverged by the light diverging element,
wherein the diffraction grating is formed on a rectangular substrate made of a light-transmitting material.

2. The optical pick-up apparatus of claim 1, wherein the diffraction grating is disposed between the light source and the light diverging element.

3. The optical pick-up apparatus of claim 1, wherein the diffraction grating is formed on the substrate on a surface facing the light source, and the light diverging element is formed on the substrate on a surface facing the light collecting means.

4. The optical pick-up apparatus of claim 3, wherein the light source is formed integrally with the substrate on which the diffraction grating and the light diverging element are formed.

5. The optical pick-up apparatus of claim 1, wherein the light source is formed in such a manner that an outer shape thereof is shaped like a rectangular parallelepiped, and that a width w, which is a dimension in a direction parallel to a surface of the optical recording medium, is larger than a thickness t, which is a dimension in a direction perpendicular to the surface of the optical recording medium (w>t).

6. An optical pick-up apparatus that records information in an optical recording medium and/or reproduces information from the optical recording medium by means of light, comprising:
a light source for emitting light;
a diffraction grating for diffracting light emitted from the light source, the diffraction grating being formed line-symmetrically with respect to a virtual line perpendicular to a radius direction of the optical recording medium in an attached state, and divided into a plurality of diffraction regions formed in such a manner that each has an inclination angle with respect to the virtual line and grating cycles of adjacent diffraction regions have a phase difference of 180 degrees with each other;
light collecting means for collecting light emitted from the light source onto the optical recording medium;
a light diverging element for diverging reflection light reflected on the optical recording medium; and
a light receiving element for receiving the reflection light diverged by the light diverging element,
wherein the diffraction grating is formed integrally with the light collecting means.
